(19) United States
(12) Patent Application Publication
(10) Pub. No.: US 2019/0266545 A1
(43) Pub. Date: Aug. 29, 2019

(54) SALES REPRESENTATIVE OPTIMIZATION SYSTEM

(71) Applicant: Terraboost Media, LLC, Miami, FL (US)

(72) Inventor: Brian L Morrison, Miami, FL (US)

(73) Assignee: Terraboost Media, LLC, Miami, FL (US)

(21) Appl. No.: 16/226,460

(22) Filed: Dec. 19, 2018

Related U.S. Application Data
(60) Provisional application No. 62/607,851, filed on Dec. 19, 2017.

(51) Int. Cl. G06Q 10/06; G06Q 10/10; G06Q 30/02

(52) U.S. Cl. CPC G06Q 10/063112; G06Q 30/0204; G06Q 10/1097; G06Q 10/06398

(57) ABSTRACT

A salesperson optimization system comprising a database in communication with one or more computing devices via a network. The database is configured to store instructions executable by a processor. A comparator compares a plurality of salesperson metrics which include a location, a rating, and an availability for each salesperson in relation to a lead. A preferred salesperson is determined and notified of the lead.

The present application claims the priority benefit of U.S. Provisional Application No. 62/607,851 filed on Dec. 19, 2017, entitled “SALES REPRESENTATIVE OPTIMIZATION SYSTEM.” The disclosure of the foregoing application is incorporated herein by reference in its entirety.

### FIELD

The present invention generally relates to a system for optimizing the time of expensive outside sales representatives.

### BACKGROUND

Companies and their millions of sales representatives around the world do the best they can with the scarce resources they have. Given that all business relies on revenue which is derived from sales, high quality sales professionals currently demand high salaries, benefits, vacation time and are crucial for an organization's success yet paradoxically are extremely difficult to monitor and manage due to the fact they are not generally in a monitored office environment which reduces their efficiency and effectiveness. Making matters worse, in some organizations, there is no distinction between outside and inside sales representatives and thus high paid outside sales representatives are responsible for the entire sales process, beginning at the identification of leads, getting the lead interested in the product or service, convincing the lead to set a meeting or a discussion (sometimes over phone or web), then putting together a proposal, then sending the proposal, then waiting for an answer and following up to try to make a sale. Based on the myriad of steps and the complexity of each stage many representatives fail.

Some organizations divide the sales discipline between inside and outside sales representatives in a way to better leverage time and organize tasks so representatives can establish proficiencies. For example, an inside sales representative or lead generator can be responsible for calling the lead to set an appointment (and sometimes gathering and qualifying the lead) from a comfortable and organized office where internet and other office tools are readily available allowing them to be efficient.

Due to modern technologies, it has become easy to hire people to work from their homes, driving down the cost of inside sales representatives by eliminating commutes & allowing them flexible work balance. Therefore it's wise to maximize the number of the lead generator, or inside salespersons an organization has, and it's usually easy to measure their effectiveness. These inside representatives will set appointments for the outside representatives (who are usually higher paid professionals/closers) who can attend the meeting and in some cases closing the sale right there on the spot. Contrast this against an unoptimized and unsupported outside sales representative responsible for the entire sales process, where it is very common that they will go an entire day without setting 1 appointment or sitting down in 1 meeting whereas if the workflow is optimized the inside sales representative may set 7-10 appointments allowing an outside sales representative to attend 3-4 meetings per day in some industries, which is a massive productivity boost as the rep is thus spending their time doing what they do best and in revenue-generating mission critical closing activities (instead of wasting time), driving down the average cost per meeting and driving up their productivity and the amount of revenue capable of being generated by a single representative. The full potential of sales force efficiency, however, will only be realized if the technology is woven together in a way that will maximize meetings and sales.

In most sales organizations, a representative's ultimate success is a formula based on the number of meetings he or she sits in, and the skill he or she possesses in explaining a product or service, their ability to raise a value proposition strong enough in the prospect's perspective to the point that they can have the confidence to ask for a sale, and ultimately close a sale. Without the invention the success of even the most capable and talented representative will be limited because he or she will not possess the resources and time management tools in order to optimize the aggregation of the most geographically desirable leads, with the connection of the real-time calendar availability with the very best leads being called at the very best time, with the right script (which raises urgency to alert the prospect the sales representative is literally right in the neighborhood) by a large group of inside sales representatives that are following a system that dictates priorities based on a series of pre-established inputs.

It can be seen that an improvement in the art of sales logistics is needed, one such improvement is described in the embodiment herein.

### SUMMARY OF THE INVENTION

A salesperson optimization system comprising a database in communication with one or more computing devices via a network. The database is configured to store instructions executable by a processor. A comparator compares a plurality of salesperson metrics which include a location, a rating, and availability for each salesperson in relation to a lead. A preferred salesperson is determined and notified of the lead.

In one aspect, a calendar module is in operable communication with the processor. The calendar module determines the availability of the salesperson at a time associated with the lead.

In another aspect, a scheduling module is in operable communication with the processor and a GPS system. The scheduling module determines the availability of the salesperson at a current location, at the time associated with the lead.

In one aspect, a telemarking system is in communication with the network. The telemarketing system is configured to call potential leads. The telemarketing system includes a database of stored contacts, wherein each of the stored contacts is given an identifier to determine the ability to call each of the stored contacts. The identifier can include a “do not call” indicator.

In one aspect, the network is in communication with an inside representative system comprised of a plurality of inside sales representatives. The telemarketing system may operate to schedule the inside sales representative for a lead.

### BRIEF DESCRIPTION OF THE DRAWINGS

A complete understanding of the embodiments, and the attendant advantages and features thereof, will be more readily understood by references to the following detailed description when considered in conjunction with the accompanying drawings wherein:

FIG. 1 illustrates a block diagram of a network infrastructure of the sales representative optimization system, according to some embodiments;

FIG. 2 illustrates a block diagram of the server engine and modules for the sales representative optimization system, according to some embodiments; and

FIG. 3 illustrates a flowchart of a method for a remote representative optimization system, according to some embodiments.

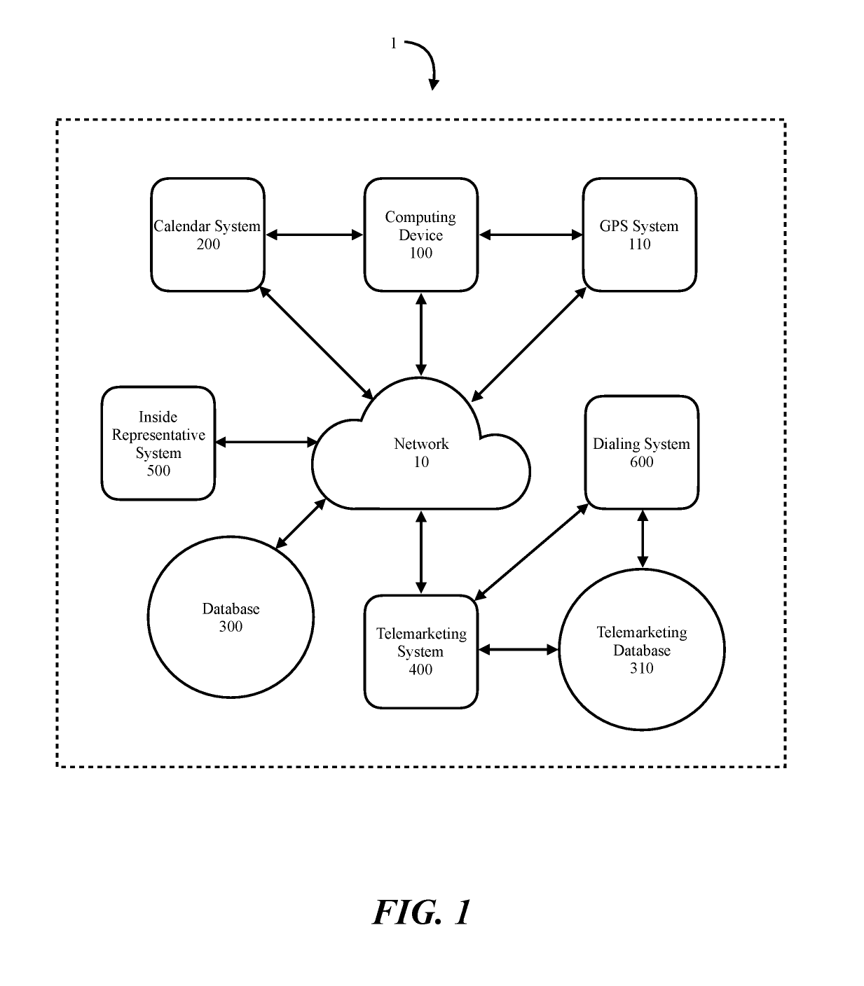

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

In general, the sales personnel optimization system utilizes a network 10 having a variety of components in wireless or wired communication with one another. A remote sales representative (commonly referred to as an outside sales representative) having personal electronic device 100 (“PED”) or similar implement having global positioning system 110 (“GPS”) allows the network to establish and track the location of the remote user. Other implements of a GPS 110 may be utilized as known in the arts. During user, GPS coordinates of the remote user are transmitted to the network for utilization by other components therein.

In some embodiments, the electronic device 100 is a computing device in wireless communication via network 10. Network server sends and receives data stored to and from a database. The network 10 may be the Internet, a cellular network, a wired network, a wireless network, a cloud computing network, or other conventional network technology recognized in the art. It should be understood that, in practice, there will be plural and likely a large number of computing devices connected to the network 10. The network server may be a unitary device but would preferably be implemented as a server farm or a distributed computing system to handle large capacities of virtual content stored in the database and the many simultaneous connections with computing devices. Further examples of communication networks include a local area network (“LAN”), a wide area network (“WAN”), an inter-network (e.g., the Internet), and peer-to-peer networks (e.g., ad hoc peer-to-peer networks).

In some embodiments, the system 1 is world-wide-web (www) based, and the network server is a web server delivering HTML, XML, etc., web pages to the computing device. In other embodiments, a client-server architecture may be implemented, in which network server executes enterprise and custom software, exchanging data with custom client applications running on the computing device.

Processors suitable for the execution of a computer program include both general and special purpose microprocessors and any one or more processors of any digital computing device. The processor will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive). Memory devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The memory module may include a computer readable medium storing the application, which may include instructions. In an embodiment, the memory module may contain different components for retrieving, presenting, changing, and saving data and may include computer-readable media. The memo module may include a variety of memory devices, for example, Dynamic Random-Access Memory (DRAM), Static RAM (SRAM), flash memory, cache memory, and other memory devices. Additionally, for example, a memory module and processors may be distributed across several different computing devices that collectively comprise a system. The memory module is capable of storing each user-generated information to be displayed on the computing device display.

Further, the remote user's calendar 200 is in communication with the system 1. Other time-tracking implements may be utilized as known in the arts. The knowledge of each outside sales representative calendar 200 availability indicates the representative's ability to accept a meeting in the future (e.g., while they are in a specific area as determined by the GPS 110 system) accessible via a database 300 which is in operable communication with a telemarketing system 400.

A telemarketing system 400 contains groups of leads that have been input into such a system for a variety of factors. The group of lists should be vetted against various “do not call” lists. The telemarketing system may be similar to those commonly used in the arts containing a list of contacts, both on “available” and “do not call” lists. A telemarketing database 310 may maintain data related to the contacts and whether the system 1 can place a call to the contact. As known in the arts, manual or auto-dialers may be utilized to execute the action of a call.

In an embodiment, the telemarketing system 400 may be staffed by Inside Sales Representatives 500 and system 1 is capable of establishing a grouping of sales leads from a radius (or maximum distance) around the location where such representative is currently located which will optimize a sales representative's chances of maximizing the number of meetings he or she can host in a day at a customer's location because the sales representative will not be spending a lot of time in the car between meetings in an un-optimized and un-dynamic way (as seen in the old methods of telemarketing sales systems, and that which the present embodiment attempts to improve upon).

In an embodiment, a telemarketing dialer system 600 delivers a script to the inside sales representative that indicates the representative is currently in the area, which provides for urgency and a higher likelihood the prospect will agree to a brief meeting. This can be opposed to a script that tries to set up a meeting in the next couple of days. This script becomes dynamic with the presence known to the prospect.

A database 300 interconnects to the telemarketing dialer system 600. The database 300 functions to block leads from being called if there is nothing to sell in the area. Or conversely, will only select leads to be called where there is some inventory to sell that is located within a determinable radius from the lead.

It is a goal of the present invention to create a telemarketing dialer system that is capable of prioritizing better performing representatives as well as prioritize calls being placed to optimize company inside sales representative calling bandwidth. First, the telemarketing system determines an appropriate contact to call in their database. This may be based on whether the contact is on a “do not call” list or not. This is followed by the system conferring with the remote representative to determine the following: 1. The specific location of a plurality of remote representatives. 2. Calendar availability of a plurality of remote representatives. 3. Determining the optimal contact in the database 300 for the dialing system 600 to contact based on location and calendar availability. It may be possible for the system to access a database 300 of remote representative statistics known in the arts, such as sales metrics, knowledge field, specialties, among others.

In an embodiment, the system is capable of prioritizing leads based on those who have bought before from a specific remote representative, or list of remote representatives (in our case they have purchased advertising before which makes them better prospects by a factor of ˜100×) and those categories (e.g. realtors who are our #1 category) who would be more likely to be interested in buying.

In an embodiment, the representative may utilize tokens, credits, or otherwise purchase “priority” for a specified period in the day.

In an embodiment, the system may deliver to the rep information about the area in which he or she is selling it. For instance, the average home value, household income, ETC to better educate and familiarize the representative. Other metrics known in the arts may be delivered, which may relate to any field of advertising or contract interest.

In an embodiment, the remote representative may be alerted when the next meeting arrives along with a link to a mapping app which will direct the representative to the next meeting. Calendar integration is also utilized to ensure scheduling fidelity.

The representative does not necessarily need to utilize an application on their smartphone to guide the day. So long as such representative's calendar, GPS coordinates, and a group of accessible and prioritizable leads are accessible by the network, this invention shall be able to be practiced. Although through an app, many other functions can be possible including and not limited to the following embodiments:
a) The representative can take photos of prospects in the field (high likelihood advertisers they find, for instance, on a bus bench) and upload through an app to the inside sales force so they can call on behalf of the representative.
b) The representative can access the auto-dialer system through the app to make calls only for themselves while in the area with the system only serving up leads from the geographical area.
c) The representatives can see in real time their performance against another representative which can inject competition and better results.

In a specific example, advertising is sold inside a specific supermarket at a specific location, for instance, a Vons in La Jolla. In each supermarket location, including the La Jolla location, 3 advertising panels are available for sale, for example here. If there is at least 1 panel available (e.g., something to sell) and the remote representative has availability in their calendar over the next 3 hours in our example, the auto-dialer will prioritize calls being made for this representative all things being equal (provided there are no other better-performing representatives). In the instant example, the auto-dialer will only dial leads that are within 5 miles of the representative, provided this lead has an address that also meets the 5-mile criteria from the supermarket. Specific mileage and other determinations are readily modifiable. For instance, the dialer can call realtors within 7 miles of where the rep is located, but only if they have an address within 3 miles of the inventory being sold (e.g., more relevant). As another example, a realtor in Del Mar, located 12 miles away, will not be called in reference to this La Jolla store because the inventory being sold will not be relevant to the realtor we're calling. However, a dentist in La Jolla (5 miles from where the rep is located, and 3 miles from the store) may very likely be called because the inventory is relevant to the potential advertiser, and there is a high degree of geo-desirability in terms of where the rep is in relation to the potential advertiser such that the number of meetings can be maximized and thus over the long-term revenue will be optimized.

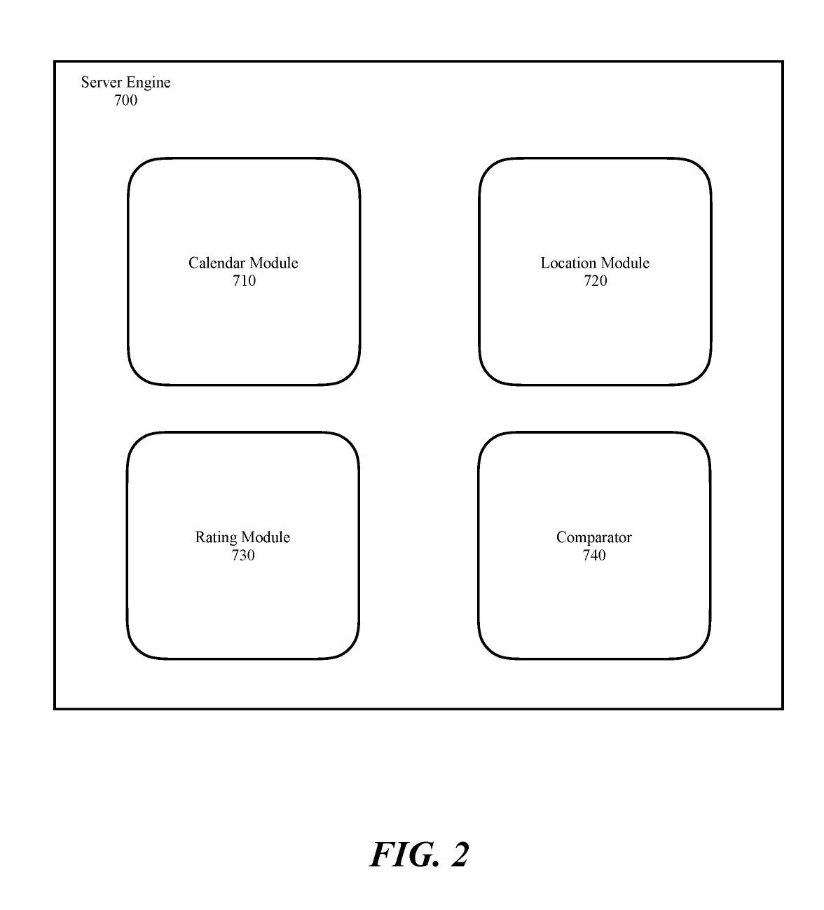

In reference to FIG. 2, the server engine 700 and modules thereof are illustrated in an exemplary embodiment. A calendar module 710 interprets calendar input by a plurality of users in communication with remote PED's within the network 10. A scheduling module 720 interprets the calendar module 710 input and consults the user rating module 730 to assess salesperson effectiveness based on previous success from the database 300.

In some embodiments, salesperson history is stored in the database 300 to indicate the success of the salesperson for each account with which they interact. The system determines, using a comparator 740 to determine the salesperson who is best optimized by schedule, location, and success potential for each sale lead available.

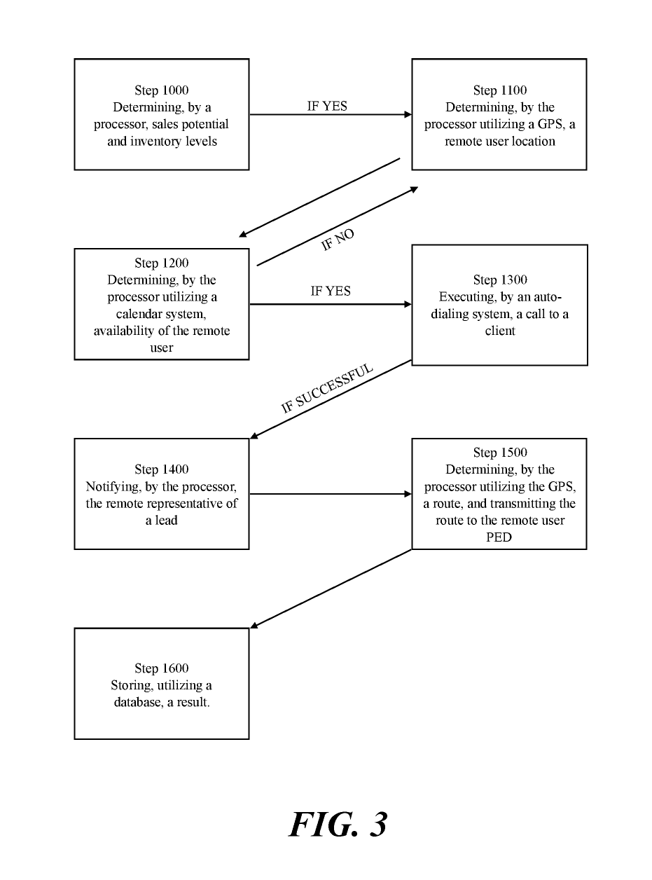

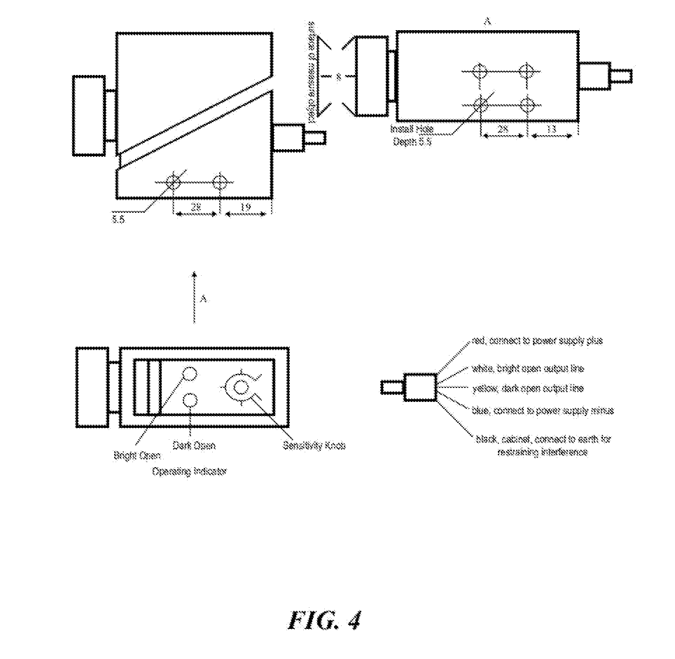

In reference to FIG. 3, an embodiment of a method for optimizing remote representatives is described. Those skilled in the arts my appreciate that alternate methods may exist gleaned from the instant embodiment. Furthermore, although FIG. 3 illustrates steps chronologically, one may appreciate that any combination of steps may be performed concurrently, or substantially concurrently while achieving the essence of the present invention. In step 1000, the network database, utilizing a processor, determines if there available and sellable inventory. In step 1100, the processor, utilizing the GPS, determines a remote user location. In step 1200, the processor, utilizing the calendar system, determines the availability of the remote user. In step 1300, the auto-dialing system executes a call to a client. In step 1400, the processor notifies the remote user of a lead and in step 1500 the route to the potential lead as determined by the GPS or similar implement. In step 1600, data may be stored related outcomes and results to any of steps 1000-1500.

It will be appreciated by persons skilled in the art that the present embodiment is not limited to what has been particularly shown and described hereinabove. A variety of modifications and variations are possible in light of the above teachings without departing from the following claims.

What is claimed is:

1. A salesperson optimization system comprising:
a database in communication with one or more computing devices via a network, the database is configured to store instructions executable by a processor, the processor including instructions to:
comparing, via a compactor, a plurality of salesperson metrics, the salesperson metrics comprised of a location, a rating, and availability for each salesperson;
determining a preferred salesperson for a lead; and
notifying the preferred salesperson of the lead.

2. The system of claim 1, wherein a calendar module is in operable communication with the processor, wherein the calendar module determines the availability of the salesperson at a time associated with the lead.

3. The system of claim 2, wherein a scheduling module in operable communication with the processor and a GPS, wherein the scheduling module determines the availability of the salesperson at a current location, at the time associated with the lead.

4. The system of claim 1, further comprising a telemarketing system configured to call potential leads.

5. A salesperson optimization system comprising:
a database in communication with one or more computing devices via a network, the database is configured to store instructions executable by a processor, the processor including instructions to:
comparing, via a compactor, a plurality of salesperson metrics, the salesperson metrics comprised of a location, a rating, and an availability for each salesperson;
calling, via a telemarketing system, a prospective lead;
determining a preferred salesperson for a lead;
schedule, via a calendar module, the preferred salesperson to engage with the lead; and
notifying the preferred salesperson of the lead.

6. The system of claim 5, wherein a calendar module is in operable communication with the processor, wherein the calendar module determines the availability of the salesperson at a time associated with the lead.

7. The system of claim 6, wherein a scheduling module in operable communication with the processor and a GPS, wherein the scheduling module determines the availability of the salesperson at a current location, at the time associated with the lead.

8. The system of claim 5, further comprising a telemarketing system includes a database of stored contacts, wherein each of the stored contacts is given an identifier to determine the ability to call each of the stored contacts.

9. The system of claim 8, further comprising an inside representative system comprised of a plurality of inside sales representatives in communication with the telemarketing system via the network.
